(19) United States
(12) Patent Application Publication
(10) Pub. No.: US 2025/0272041 A1
(43) Pub. Date: Aug. 28, 2025

(54) RELAY DEVICE, COMMUNICATION CONTROL SYSTEM, INFORMATION PROCESSING DEVICE, AND CONTROL METHOD FOR RELAY DEVICE

(71) Applicant: SEIKO EPSON CORPORATION, Tokyo (JP)

(72) Inventor: Rio YAMAZAKI, SHIOJIRI-SHI (JP)

(21) Appl. No.: 19/060,995

(22) Filed: Feb. 24, 2025

(30) Foreign Application Priority Data
Feb. 26, 2024 (JP) 2024-026902

(51) Int. Cl. G06F 3/12

(52) U.S. Cl. CPC G06F 3/1288; G06F 3/1203; G06F 3/1236; G06F 3/1297

(57) ABSTRACT

A hub is a hub that relays communication between a personal computer and a printer, and includes a first processor that controls the hub and a first non-volatile memory, and the first non-volatile memory stores a first control program that causes the first processor to control the hub and a second control program that controls the printer.

The present application is based on, and claims priority from JP Application Serial Number 2024-026902, filed Feb. 26, 2024, the disclosure of which is hereby incorporated by reference herein in its entirety.

### BACKGROUND

### 1. Technical Field

The present disclosure relates to a relay device, a communication control system, an information processing device, and a control method for a relay device.

### 2. Related Art

JP 2017-84154 A discloses a configuration of a printer including a non-volatile storage unit.

In the past, in a printer such as a thermal head printer, it has been desired to reduce capacity of a non-volatile memory that stores firmware or the like.

### SUMMARY

A relay device according to an aspect for solving the above-described problems is a relay device that relays communication between an information processing device and a printing device, the relay device including a first processor configured to control the relay device, and a first non-volatile memory, wherein the first non-volatile memory stores a first control program that causes the first processor to perform control of the relay device, and at least a part of a second control program that controls the printing device.

A communication control system according to another aspect for solving the above-described problems includes a printing device, and a relay device configured to communicate with the printing device, wherein the relay device includes a first processor that controls the relay device, and a first non-volatile memory, and the first non-volatile memory stores a first control program that causes the first processor to perform control of the relay device, and at least a part of a second control program that controls the printing device.

An information processing device according to still another aspect for solving the above-described problems is an information processing device that communicates with a printing device via a relay device, wherein when a second control program that controls the printing device is updated, at least a part of the second control program is sent to the relay device.

A control method for a relay device according to yet another aspect for solving the above-described problems is a control method for a relay device that relays communication between an information processing device and a printing device, the control method including storing at least a part of a second control program that controls the printing device, reading the at least a part of the second control program when power of the printing device and the relay device is turned on, and sending the at least a part of the second control program read to the printing device.

### BRIEF DESCRIPTION OF THE DRAWINGS

FIG. 1 is a diagram illustrating an example of a configuration of a communication control system according to the embodiment.

FIG. 2 is a diagram illustrating an example of configurations of a first control unit and a second control unit according to the embodiment.

FIG. 3 is a flowchart illustrating an example of processing of the first control unit and the second control unit.

### DESCRIPTION OF EMBODIMENTS

Hereinafter, embodiments will be described with reference to the drawings.

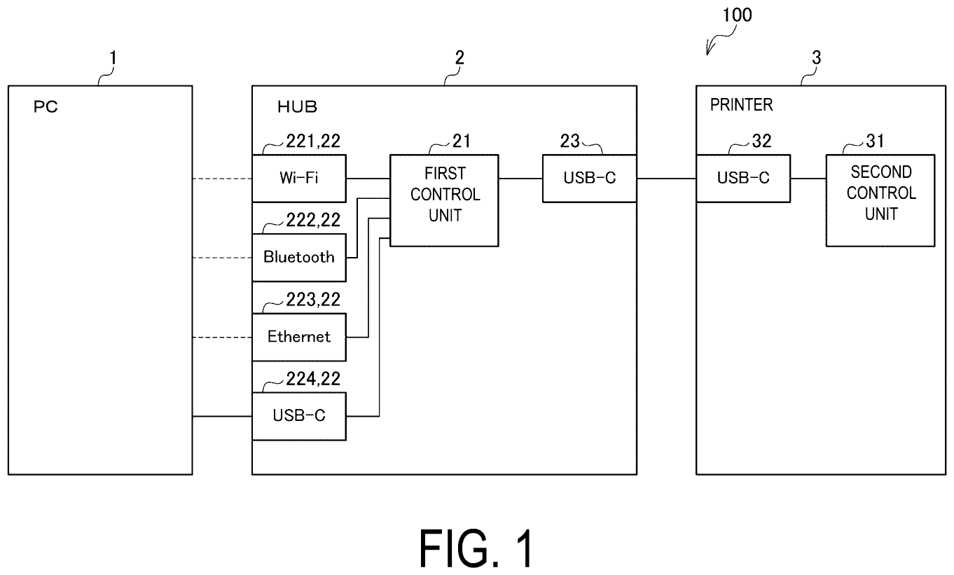

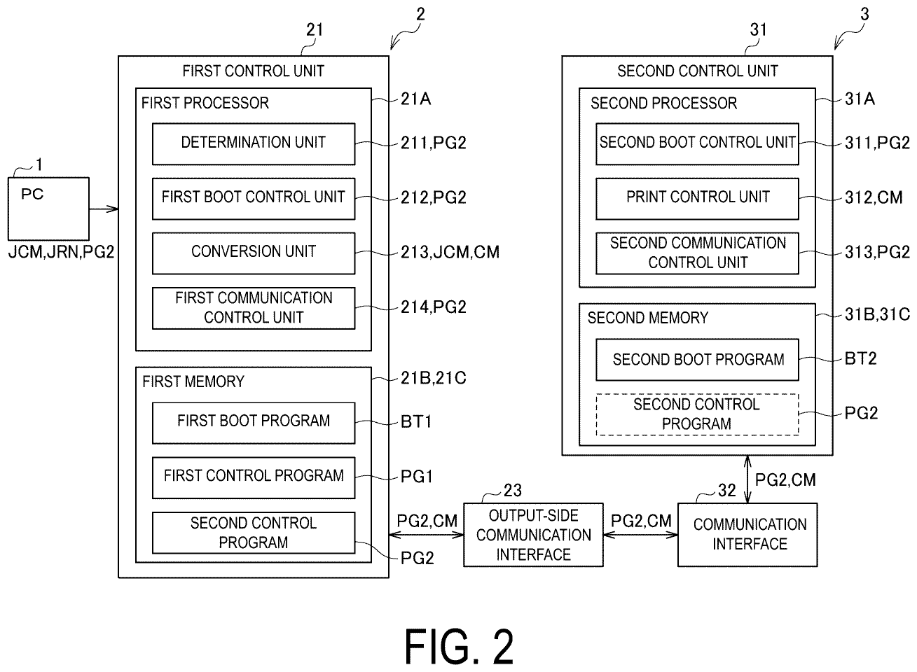

FIG. 1 is a diagram illustrating an example of a configuration of a communication control system 100. FIG. 2 is a diagram illustrating an example of a configuration of a first control unit 21 of a hub 2 according to the embodiment.

As illustrated in FIG. 1, the communication control system 100 includes a personal computer 1, a hub 2, and a printer 3.

The personal computer 1 outputs instruction information to the printer 3 via the hub 2. In addition, the personal computer 1 is configured to be able to communicate with the hub 2 according to, for example, each of the Wi-Fi (registered trademark) standards, the Bluetooth (registered trademark) standards, the Ethernet (registered trademark) standards, and the Universal Serial Bus (USB) (registered trademark).

The personal computer 1 corresponds to an example of an “information processing device”.

The hub 2 relays communication between the personal computer 1 and the printer 3. The hub 2 includes the first control unit 21, an input-side communication interface 22, and an output-side communication interface 23.

The hub 2 corresponds to an example of a “relay device”.

As illustrated in FIG. 2, the first control unit 21 includes a first processor 21A such as a Central Processing Unit (CPU), a first memory device 21B such as a Read Only Memory (ROM) or a Random Access Memory (RAM), other peripheral circuits, and the like, and controls each unit of the hub 2.

The first memory device 21B includes a non-volatile memory such as an Electrically Erasable Programmable Read-Only Memory (EEPROM), a Solid State Drive (SSD), or a Hard Disk Drive (HDD). The first memory device 21B stores a first control program PG1.

The non-volatile memory such as an EEPROM, an SSD, or an HDD of the first memory device 21B corresponds to an example of a “first non-volatile memory”. In the embodiment, the non-volatile memory such as an EEPROM, an SSD, or an HDD of the first memory device 21B is described as a first non-volatile memory 21C.

The first processor 21A may be configured by a single processor, or a configuration may be adopted in which a plurality of processors function as the first processor 21A. In the embodiment, for example, three processors function as the first processor 21A.

A function of the first control unit 21 may be achieved by one or more processors or semiconductor chips. The first control unit 21 may be configured to further include a co-processor such as a System-on-a-Chip (SoC), a Micro Control Unit (MCU), and a Field-Programmable Gate Array (FPGA). The first control unit 21 may cause both the CPU and the co-processor to cooperate with each other, or selectively use either one of the both to perform various types of controls.

The input-side communication interface 22 is a communication interface for communicating with the personal computer 1. The input-side communication interface 22 includes a first communication interface 221, a second communication interface 222, a third communication interface 223, and a fourth communication interface 224.

In the embodiment, the personal computer 1 is coupled to, for example, the fourth communication interface 224.

The first communication interface 221 communicates with the personal computer 1 according to, for example, the Wi-Fi (registered trademark) standards in accordance with an instruction from the first control unit 21. The first communication interface 221 includes an antenna that transmits and receives Wi-Fi (registered trademark) signals, and an interface circuit that processes the Wi-Fi (registered trademark) signals. The first communication interface 221 is an interface board including an interface circuit, and is coupled to a main board on which the first processor 21A of the first control unit 21 and the like are mounted. Alternatively, the interface circuit included in the first communication interface 221 is mounted at the main board of the first control unit 21.

The second communication interface 222 communicates with the personal computer 1 according to, for example, the Bluetooth (registered trademark) standards in accordance with an instruction from the first control unit 21. The second communication interface 222 includes an antenna that transmits and receives Bluetooth (registered trademark) signals, and an interface circuit that processes the Bluetooth (registered trademark) signals. The second communication interface 222 is an interface board including an interface circuit, and is coupled to the main board on which the first processor 21A of the first control unit 21 and the like are mounted. Alternatively, the interface circuit included in the second communication interface 222 is mounted at the main board of the first control unit 21.

The third communication interface 223 communicates with the personal computer 1 according to, for example, the Ethernet (registered trademark) standards in accordance with an instruction from the first control unit 21. The third communication interface 223 includes a connector that transmits and receives Ethernet (registered trademark) signals, and an interface circuit that processes the Ethernet (registered trademark) signals. The third communication interface 223 is an interface board including an interface circuit, and is coupled to the main board on which the first processor 21A of the first control unit 21 and the like are mounted. Alternatively, the interface circuit included in the third communication interface 223 is mounted at the main board of the first control unit 21.

The fourth communication interface 224 communicates with the personal computer 1 according to, for example, the USB (registered trademark) standards in accordance with an instruction from the first control unit 21. The fourth communication interface 224 includes a connector that transmits and receives USB (registered trademark) signals, and an interface circuit that processes the USB (registered trademark) signals. The connector is, for example, a so-called USB (registered trademark) type C connector. The fourth communication interface 224 is an interface board including an interface circuit, and is coupled to the main board on which the first processor 21A of the first control unit 21 and the like are mounted. Alternatively, the interface circuit included in the fourth communication interface 224 is mounted at the main board of the first control unit 21.

The output-side communication interface 23 is a communication interface for communicating with the printer 3.

The output-side communication interface 23 communicates with the printer 3 according to, for example, the USB (registered trademark) standards in accordance with an instruction from the first control unit 21. The output-side communication interface 23 includes a connector that transmits and receives USB (registered trademark) signals, and an interface circuit that processes the USB (registered trademark) signals. The connector is, for example, a so-called USB (registered trademark) type C connector. The output-side communication interface 23 is an interface board including an interface circuit, and is coupled to the main board on which the first processor 21A of the first control unit 21 and the like are mounted. Alternatively, the interface circuit included in the output-side communication interface 23 is mounted at the main board of the first control unit 21.

The printer 3 is disposed at a store such as a supermarket, for example. The printer 3 constitutes a part of a Point Of Sale (POS) system, for example.

The printer 3 is, for example, a thermal printer. For example, the printer 3 prints an image on thermal paper and outputs a receipt.

The printer 3 corresponds to an example of a “printing device”.

Further, in the embodiment, the printer 3 is a “dedicated printer”. The “dedicated printer” is a printer configured on the premise of being coupled to the hub 2 according to the embodiment.

The printer 3 includes a second control unit 31 and a communication interface 32.

The second control unit 31 includes a second processor 31A such as a CPU, a second memory device 31B such as a ROM, a RAM, or the like, other peripheral circuits, and the like, and controls each unit of the printer 3.

The second memory device 31B includes a non-volatile memory such as an EEPROM, an SSD, or an HDD. The second memory device 31B stores a second control program PG2.

The non-volatile memory such as an EEPROM, an SSD, or an HDD of the second memory device 31B corresponds to an example of a “second non-volatile memory”. In the embodiment, the non-volatile memory such as an EEPROM, an SSD, or an HDD of the second memory device 31B is described as a second non-volatile memory 31C.

The second processor 31A may be configured by a single processor, or a configuration may be adopted in which a plurality of processors function as the second processor 31A.

A function of the second control unit 31 may be achieved by one or more processors or semiconductor chips. The second control unit 31 may be configured to further include a co-processor such as an SoC, an MCU, or an FPGA. The second control unit 31 may cause both the CPU and the co-processor to cooperate with each other, or selectively use either one of the both to perform various types of controls.

The communication interface 32 communicates with the hub 2 according to, for example, the USB (registered trademark) standards in accordance with an instruction from the second control unit 31. The communication interface 32 includes a connector that transmits and receives USB (registered trademark) signals, and an interface circuit that processes the USB (registered trademark) signals. The connector is, for example, a so-called USB (registered trademark) type C connector. The communication interface 32 is an interface board including an interface circuit, and is coupled to a main board on which the second processor 31A of the second control unit 31 and the like are mounted. Alternatively, the interface circuit included in the communication interface 32 is mounted at the main board of the second control unit 31.

Next, the configuration of the first control unit 21 of the hub 2, and a configuration of the second control unit 31 of the printer 3 will be described with reference to FIG. 2. FIG. 2 is a diagram illustrating an example of the configurations of the first control unit 21 and the second control unit 31 according to the embodiment.

First, the configuration of the first control unit 21 will be described.

As illustrated in FIG. 2, the first non-volatile memory 21C stores a first boot program BT1. The first boot program BT1 is a program for performing a startup processing of the hub 2. The first boot program BT1 is read from the first non-volatile memory 21C by the first processor 21A, loaded in the RAM or the like for execution. By the first processor 21A executing the first boot program BT1, the startup processing of the hub 2 is performed. In the following description, the startup processing of the hub 2 may be described as “a first boot processing”.

The first control unit 21 includes a determination unit 211, a first boot control unit 212, a conversion unit 213, and a first communication control unit 214.

For example, when the startup processing of the hub 2, that is, the first boot processing is completed, the first processor 21A executes the first control program PG1 stored in the first memory device 21B. Then, by executing the first control program PG1 stored in the first memory device 21B, the first processor 21A functions as the determination unit 211, the first boot control unit 212, the conversion unit 213, and the first communication control unit 214.

In the embodiment, the first control program PG1 is stored in the first non-volatile memory 21C.

The first non-volatile memory 21C stores at least a part of the second control program PG2 in advance.

Note that in the following description, for convenience, a case where “the at least a part of the second control program PG2” is the second control program PG2 will be described. That is, a case where the first non-volatile memory 21C of the first memory device 21B stores the second control program PG2 will be described.

The second control program PG2 is the second control program PG2 excluding the second boot program BT2 for starting the printer 3. In other words, the second boot program BT2 for starting the printer 3 is not stored in the first non-volatile memory 21C.

The second boot program BT2 for starting the printer 3 is stored in the second non-volatile memory 31C of the printer 3.

The second control program PG2 stored in the first non-volatile memory 21C is read out by the first boot control unit 212.

The second control program PG2 includes, for example, a printing program for controlling a printing processing of the printer 3. Further, the second control program PG2 may include, for example, a so-called mechanical control program that controls hardware such as a recording head, a transport roller, and the like that perform the printing processing of the printer 3.

When the second control program PG2 is not stored in the first non-volatile memory 21C, the determination unit 211 determines that the printer 3 cannot be started.

When the determination unit 211 determines that the printer 3 cannot be started, for example, the first control unit 21 does not supply power to the printer 3. Further, when the determination unit 211 determines that the printer 3 cannot be started, for example, the first control unit 21 does not instruct to turn on power to the printer 3.

When the determination unit 211 determines that the printer 3 can be started, the first boot control unit 212 supplies power to the printer 3. Then, the first boot control unit 212 instructs the printer 3 to turn on power. In addition, the first boot control unit 212 instructs the printer 3 to start.

In addition, when the startup of the printer 3 is completed, the first boot control unit 212 reads the second control program PG2 stored in the first non-volatile memory 21C and sends the read second control program PG2 to the second processor 31A of the printer 3.

For example, when data JC received from the personal computer 1 is the data JC in an Extensible Markup Language (XML) format or a text format, and is command data JCM to the printer 3, the conversion unit 213 performs the following processing.

That is, the conversion unit 213 performs a processing of converting the command data JCM into a command CM.

The first communication control unit 214 controls communication with the personal computer 1 via the fourth communication interface 224 of the input-side communication interface 22.

For example, when the second control program PG2 stored in the first non-volatile memory 21C is updated, the personal computer 1 sends update instruction information JRN for instructing the update of the second control program PG2 to the hub 2. When the update instruction information JRN is received, the first communication control unit 214 of the hub 2 acquires a new second control program PG2 from the personal computer 1. Then, the first processor 21A writes the new second control program PG2 acquired by the first communication control unit 214 to the first non-volatile memory 21C in place of the stored second control program PG2.

Further, the first communication control unit 214 controls communication with the printer 3 via the output-side communication interface 23. For example, the first communication control unit 214 sends the second control program PG2 stored in the first non-volatile memory 21C to the printer 3.

Next, with reference to FIG. 2, the configuration of the second control unit 31 of the printer 3 will be described.

As illustrated in FIG. 2, the second non-volatile memory 31C of the second memory device 31B stores the second boot program BT2. The second boot program BT2 is a program for performing a startup processing of the printer 3.

The second boot program BT2 includes initial setting of the second processor 31A and initial setting of the communication interface 32.

The second boot program BT2 is read from the second non-volatile memory 31C by the second processor 31A, loaded in the RAM or the like, and executed. By the second processor 31A executing the second boot program BT2, the startup processing of the printer 3 is performed. For example, when the startup processing of the printer 3 is completed, the second processor 31A functions as a second boot control unit 311 and a second communication control unit 313.

In the following description, the startup processing of the printer 3 may be described as a “second boot processing”.

The second control unit 31 includes the second boot control unit 311, a print control unit 312, and the second communication control unit 313.

The second boot control unit 311 receives the second control program PG2 stored in the first memory device 21B, for loading in the RAM or the like and execution. By executing the second control program PG2, the first processor 21A functions as the print control unit 312.

In the embodiment, the second control program PG2 is not stored in the second non-volatile memory 31C of the second memory device 31B.

For example, the print control unit 312 prints an image on thermal paper and outputs a receipt. When the command CM instructing printing is received from the hub 2, the print control unit 312 prints an image on the thermal paper according to the command CM and outputs a receipt. Note that the command CM is generated by the conversion unit 213 of the hub 2 converting the command data JCM received from the personal computer 1 into the command CM.

The second communication control unit 313 communicates with the hub 2 via the communication interface 32. For example, the second communication control unit 313 receives the second control program PG2 from the hub 2. Further, the second communication control unit 313 receives the command CM from the hub 2.

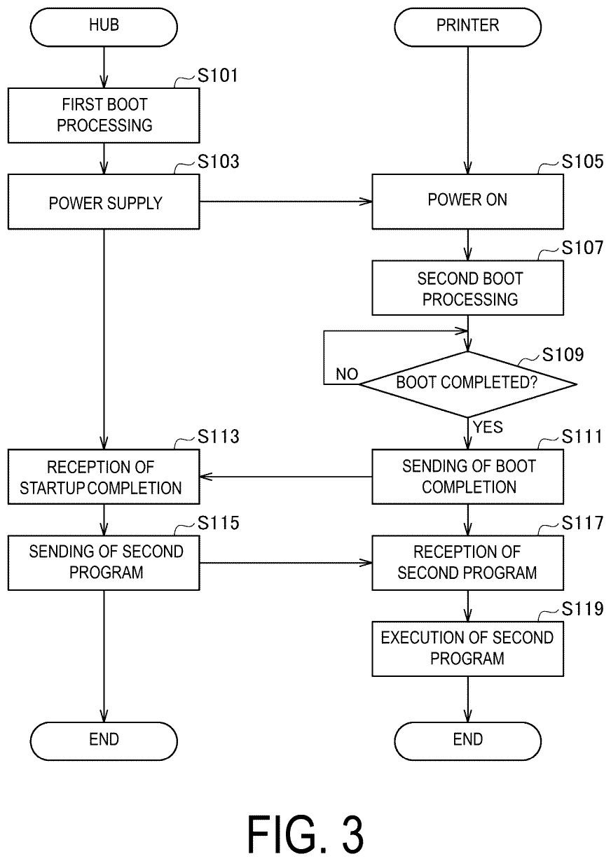

Next, processing of the first control unit 21 of the hub 2, and processing of the second control unit 31 of the printer 3 will be described with reference to FIG. 3. FIG. 3 is a flowchart illustrating an example of the processing of the first control unit 21 and the second control unit 31. Note that FIG. 3 describes a case where the second control program PG2 is stored in the first non-volatile memory 21C.

First, in step S101, the first processor 21A of the first control unit 21 performs the first boot processing. To be specific, the first processor 21A reads the first boot program BT1 from the first non-volatile memory 21C. Then, the first processor 21A loads the first boot program BT1 in the RAM or the like for execution. By the first processor 21A executing the first boot program BT1, the first boot processing is performed.

Next, in step S103, the first boot control unit 212 of the first control unit 21 supplies power to the printer 3. Then, the first boot control unit 212 instructs the printer 3 to turn on power. In addition, the first boot control unit 212 instructs the printer 3 to start.

Next, in step S105, the printer 3 turns on power according to an instruction from the first boot control unit 212 of the first control unit 21.

Next, in step S107, the printer 3 performs the second boot processing according to an instruction from the first boot control unit 212 of the first control unit 21. To be specific, the second processor 31A of the printer 3 reads the second boot program BT2 from the second non-volatile memory 31C. Then, the second processor 31A loads the second boot program BT2 in the RAM or the like for and execution. By the second processor 31A executing the second boot program BT2, the startup processing of the printer 3, that is, the second boot processing is performed.

Next, in step S109, the second boot control unit 311 of the second control unit 31 determines whether the second boot processing is completed or not.

When the second boot control unit 311 determines that the second boot processing is not completed (Step S109; NO), the processing is brought into a waiting state. When the second boot control unit 311 determines that the second boot processing is completed (Step S109; YES), the processing proceeds to step S111.

Then, in step S111, the second boot control unit 311 sends boot completion information indicating that the second boot processing is completed to the hub 2.

Next, in step S113, the first boot control unit 212 of the first control unit 21 receives the boot completion information indicating that the second boot processing is completed.

Next, in step S115, the first boot control unit 212 reads the second control program PG2 stored in the first non-volatile memory 21C, and sends the read second control program PG2 to the printer 3.

Next, in step S117, the second boot control unit 311 of the second control unit 31 receives the second control program PG2 from the hub 2.

Next, in step S119, the second boot control unit 311 loads the second control program PG2 into the RAM or the like for execution. Then, the processing is terminated.

As described above with reference to the drawings, the hub 2 according to the embodiment is the hub 2 that relays communication between the personal computer 1 and the printer 3, and includes the first processor 21A that controls the hub 2 and the first non-volatile memory 21C, and the first non-volatile memory 21C stores the first control program PG1 that causes the first processor 21A to perform control of the hub 2, and the second control program PG2 that controls the printer 3.

According to this configuration, since the first non-volatile memory 21C of the hub 2 stores the second control program PG2 that controls the printer 3, it is possible to reduce capacity of the second non-volatile memory 31C of the printer 3.

In addition, in the hub 2 according to the embodiment, the printer 3 includes the second non-volatile memory 31C, the second non-volatile memory 31C stores the second boot program BT2 of the printer 3, and when power of the printer 3 and the hub 2 is turned on, the first processor 21A reads the first control program PG1 from the first non-volatile memory 21C, executes the first control program PG1, reads the second control program PG2 stored in the first non-volatile memory 21C, and sends the read second control program PG2 to the second processor 31A of the printer 3.

According to this configuration, the first processor 21A sends the second control program PG2 stored in the first non-volatile memory 21C to the second processor 31A of the printer 3. Therefore, the second processor 31A can control the printer 3 by executing the second control program PG2.

In addition, in the hub 2 according to the embodiment, the second control program PG2 is a control program excluding the second boot program BT2 of the printer 3.

According to this configuration, since the second control program PG2 is the control program excluding the second boot program BT2 of the printer 3, it is possible to appropriately set the second control program PG2 stored in the first non-volatile memory 21C.

In addition, in the hub 2 according to the embodiment, the second boot program BT2 includes initial setting of the second processor 31A and initial setting of the communication interface 32.

According to this configuration, by executing the second boot program BT2, the initial setting of the second processor 31A and the initial setting of the communication interface 32 are performed. Therefore, when the second boot program BT2 is executed, the second processor 31A can receive the second control program PG2 via the communication interface 32.

In addition, in the hub 2 according to the embodiment, when the second control program PG2 is not stored in the first non-volatile memory 21C, the first processor 21A determines that the printer 3 cannot be started.

According to this configuration, when the second control program PG2 is not stored in the first non-volatile memory 21C, it is determined that the printer 3 cannot be started, and thus it is possible to appropriately determine whether the printer 3 can be started or not.

In addition, in the hub 2 according to the embodiment, when the second control program PG2 is updated, the first processor 21A acquires the second control program PG2 from the personal computer 1 for writing data in the first non-volatile memory 21C.

According to this configuration, the second control program PG2 can be easily updated.

In addition, in the hub 2 according to the embodiment, the printer 3 is coupled to the hub 2 by a type C connector of the USB-standards, and the first processor 21A communicates with the second processor 31A with a type C of the USB-standards.

According to this configuration, communication at a high speed is enabled compared to a case where the printer 3 is coupled to the hub 2 by a type A connector of the USB-standards.

In addition, in the hub 2 according to the embodiment, when the command data JCM corresponding to the command CM which instructs the printer 3 to perform processing is received from the personal computer 1, the first processor 21A converts the command data JCM into the command CM.

According to this configuration, since the command data JCM is converted into the command CM, the data JC in an XML format or a text format can be used as the command data JCM. Therefore, it is possible to simplify the instruction from the personal computer 1 to the printer 3 to perform processing.

The communication control system 100 according to the embodiment includes the printer 3 and the hub 2 that communicates with the printer 3, the hub 2 includes the first processor 21A that controls the hub 2, and the first non-volatile memory 21C, and the first non-volatile memory 21C stores the first control program PG1 that causes the first processor 21A to control the hub 2, and the second control program PG2 that controls the printer 3.

According to this configuration, the communication control system 100 according to the embodiment achieves the same operational effects as the hub 2 according to the embodiment.

The personal computer 1 according to the embodiment is the personal computer 1 that communicates with the printer 3 via the hub 2, and when the second control program PG2 that controls the printer 3 is updated, sends the second control program PG2 to the hub 2.

With this configuration, the personal computer 1 according to the embodiment can easily update the second control program PG2.

A communication control method for the hub 2 according to the embodiment is a control method for the hub 2 that relays communication between the personal computer 1 and the printer 3, in which a second control program PG2 that controls the printer 3 is stored, the second control program PG2 is read when power of the printer 3 and the hub 2 is turned on, and the read second control program PG2 is sent to the printer 3.

According to this configuration, the communication control method for the hub 2 according to the embodiment achieves the same operational effects as the hub 2 according to the embodiment.

Note that the embodiments described above merely represent one aspect of the present disclosure and any variation and application may be possible within the scope of the present disclosure.

In the embodiment, the case where the “information processing device” is the personal computer 1 has been described, however, the embodiment is not limited thereto. The “information processing device” may be a tablet terminal or a smartphone, for example. Further, the “information processing device” may be a server device.

Further, in the embodiment, the case where the personal computer 1 is coupled to the fourth communication interface 224 has been described, however, the embodiment is not limited thereto. The personal computer 1 may be coupled to, for example, any one of the first communication interface 221, the second communication interface 222, and the third communication interface 223.

In addition, in the embodiment, the case where the “printing device” is the printer 3 has been described, but the embodiment is not limited thereto. It is sufficient that the “printing device” has a printing function. The “printing device” may be, for example, a copying machine. Further, the “printing device” may be a MultiFunction Peripheral (MFP).

Further, in the embodiment, the case where the printer 3 is a thermal printer has been described, however, the embodiment is not limited thereto. The printer 3 may be, for example, an inkjet printer.

In addition, in the embodiment, the case where the first non-volatile memory 21C stores the second control program PG2 has been described, but the embodiment is not limited thereto. It is sufficient that the first non-volatile memory 21C stores at least a part of the second control program PG2. For example, the first non-volatile memory 21C may store a print control program of the second control program PG2. The print control program is a control program for the second processor 31A to function as the print control unit 312.

Additionally, the communication control method achieved by the first processor 21A included in the hub 2 executing the first control program PG1 has been described in the embodiment, however, the communication control method can be configured with an aspect of a recording medium in which the first control program PG1 executed by the first processor 21A to achieve the communication control method is recorded in a computer-readable manner, or an aspect of a transmission medium for transmitting the control program.

As the above recording medium, a magnetic or optical recording medium or a semiconductor memory device can be used. A portable or stationary type recording medium, such as a flexible disk, an HDD, a Compact Disk Read Only Memory (CD-ROM), a Digital Versatile Disk (DVD), a Blu-ray (registered trademark) disc, a magneto-optical disc, a flash memory, a card type recording medium, or the like may be exemplified.

The recording medium described above may be non-volatile storage devices such as a RAM, a ROM, and the like being internal storage devices included in the hub 2.

Further, in the embodiment, the first processor 21A executes the first control program PG1 to control each unit of the hub 2, but the embodiment is not limited thereto. The first control unit 21 may include, for example, an Application Specific Integrated Circuit (ASIC), and the ASIC may perform processing by a function mounted therein. In addition, the first control unit 21 may include, for example, a signal processing circuit, and the signal processing circuit may perform a signal processing to perform processing.

In addition, the processing units in the flowchart illustrated in FIG. 3 are obtained by dividing processing in accordance with a main processing content to facilitate understanding of the processing of the first control unit 21 and the second control unit 31, thus the present disclosure is not restricted by a method for dividing the processing into the processing units and names thereof. The processing of the first control unit 21 and the second control unit 31 may be divided into more processing units according to the processing content. Further, one processing unit may be further divided to include more processing.

Furthermore, each functional unit illustrated in FIG. 2 indicates a functional configuration, and a specific implementation is not particularly restricted. In other words, hardware that corresponds individually to each of the functional units is not necessarily implemented, and a configuration in which a single processor executes a program to achieve the functions of a plurality of functional units is of course adoptable. Further, some of functions achieved by software in each of the above-described embodiments may be achieved by hardware, or some of functions achieved by hardware may be achieved by software. In addition, specific detailed configurations of the hub 2 and the printer 3 may be modified as desired without departing from the gist of the present disclosure.

What is claimed is:

1. A relay device that relays communication between an information processing device and a printing device, the relay device comprising:
a first processor configured to control the relay device; and
a first non-volatile memory, wherein
the first non-volatile memory stores a first control program that causes the first processor to perform control of the relay device, and at least a part of a second control program that controls the printing device.

2. The relay device according to claim 1, wherein
the printing device includes a second non-volatile memory,
the second non-volatile memory stores a boot program of the printing device,
when power of the printing device and the relay device is turned on,
the first processor
reads the first control program from the first non-volatile memory and executes the first control program, and
reads at least a part of the second control program stored in the first non-volatile memory, and sends the at least a part of the second control program read to a second processor of the printing device.

3. The relay device according to claim 2, wherein
the at least a part of the second control program is a control program excluding the boot program of the printing device.

4. The relay device according to claim 3, wherein
the boot program includes initial setting of the second processor and initial setting of a communication interface.

5. The relay device according to claim 1, wherein
when at least a part of the second control program is not stored in the first non-volatile memory, the first processor determines that the printing device is not configured to be started.

6. The relay device according to claim 5, wherein
when the at least a part of the second control program is updated, the first processor acquires the at least a part of the second control program from the information processing device for writing data in the first non-volatile memory.

7. The relay device according to claim 2, wherein
the printing device is coupled to the relay device with a type C connector of USB standard, and
the first processor communicates with the second processor with a type C of the USB standard.

8. The relay device according to claim 1, wherein
upon receiving command data corresponding to a command instructing the printing device to perform processing from the information processing device, the first processor converts the command data into the command.

9. A communication control system, comprising:
a printing device; and
the relay device according to claim 1 configured to communicate with the printing device, wherein
the relay device includes a first processor that controls the relay device, and a first non-volatile memory, and
the first non-volatile memory stores a first control program that causes the first processor to perform control of the relay device, and at least a part of a second control program that controls the printing device.

10. An information processing device that communicates with a printing device via a relay device, the information processing device being configured to, when a second control program that controls the printing device is updated, send at least a part of the second control program to the relay device.

11. A control method for a relay device that relays communication between an information processing device and a printing device, the control method comprising:
storing at least a part of a second control program that controls the printing device;
reading the at least a part of the second control program when power of the printing device and the relay device is turned on, and sending the at least a part of the second control program read to the printing device.
